(19) United States
(12) Patent Application Publication
(10) Pub. No.: US 2003/0128243 A1
(43) Pub. Date: Jul. 10, 2003

(54) Tree-structured diagram output method and program

(76) Inventors: Hiroyuki Okamoto, Kanagawa (JP); Yohichiro Miyaguchi, Kanagawa (JP); Yasushi Nakazato, Tokyo (JP)

Correspondence Address: MORRISON & FOERSTER LLP, 1650 TYSONS BOULEVARD, SUITE 300, MCLEAN, VA, 22102, US

(21) Appl. No.: 10/224,633

(22) Filed: Aug. 21, 2002

(30) Foreign Application Priority Data
Aug. 22, 2001 (JP) 2001-251584
Sep. 17, 2001 (JP) 2001-282414
Sep. 17, 2001 (JP) 2001-282415
Jul. 12, 2002 (JP) 2002-204207

(51) Int. Cl. G09G 5/00

(52) U.S. Cl. 345/853

(57) ABSTRACT

A tree-structured diagram output method outputs a tree-structured diagram representing association of objects. In the method, an identifier which is specific to each of the objects is assigned to every object. A first object is selected from among the objects. An identifier of the selected first object is stored into a first storage portion. A second object, different from the first object, is selected from among the objects. An identifier of the selected second object is stored into a second storage portion. The identifier of the first storage portion is associated with the identifier of the second storage portion so that the association of the identifiers of the first and second objects is obtained. A tree-structured diagram representing the association of the first and second objects is outputted based on the association of the identifiers obtained in the associating step.

### BACKGROUND OF THE INVENTION

1. Field of the Invention

The present invention relates to a tree-structured diagram outputting method and program that provides the user with a representation (or a tree-structured diagram) of the association of a plurality of objects on a computer display.

2. Description of the Related Art

In development and design processes of the products, the technique to generate a tree-structured diagram representing, for example, the association of technical subject and its solution, is known, and the tree-structured diagram is useful for the development and design processes. By using the tree-structured diagram, the development or design engineers can easily arrange the items that have to be dealt with, and the efficiency of the development and design processes can be increased.

Conventionally, the tree-structured diagram is produced by a development or design engineer through the execution of spreadsheet software or document preparation software on a computer.

However, when the renewal of the tree-structured diagram, such as the change or the addition, is needed, it is necessary to take much time and efforts for the renewal of the tree-structured diagram. There is the problem in that it is difficult to renew the previously created tree-structured diagram by using the spreadsheet software or the document preparation software.

Furthermore, when dealing with new development and design processes, it is conceivable to utilize the previously created tree-structured diagram for the progress of the new development and design processes. However, there is the problem that it is difficult to reuse the previously created tree-structured diagram.

### SUMMARY OF THE INVENTION

An object of the present invention is to provide an improved tree-structured diagram output method in which the above-described problems are eliminated.

Another object of the present invention is to provide a tree-structured diagram output method that can efficiently create a tree-structured diagram representing the association of a plurality of objects, and can easily respond to the renewal or the reuse of the tree-structured diagram.

Another object of the present invention is to provide a tree-structured diagram output program that can efficiently create a tree-structured diagram representing the association of a plurality of objects, and can easily respond to the renewal or the reuse of the tree-structured diagram.

The above-mentioned objects of the present invention are achieved by a method of outputting a tree-structured diagram representing association of objects, comprising the steps of: assigning an identifier, which is specific to each of the objects, to every object; selecting a first object from among the objects; storing an identifier of the selected first object into a first storage portion; selecting a second object, different from the first object, from among the objects; storing an identifier of the selected second object into a second storage portion; associating the identifier of the first storage portion with the identifier of the second storage portion so that association of the identifiers of the first and second objects is obtained; and outputting a tree-structured diagram representing the association of the first and second objects, based on the association of the identifiers obtained in the associating step.

The above-mentioned objects of the present invention are achieved by a computer program embodied therein for performing a tree-structured diagram output procedure to output a tree-structured diagram representing association of objects, the computer program comprising: identifier setting program code means for assigning an identifier, which is specific to each of the objects, to every object; first selection program code means for selecting a first object from among the objects; first storage program code means for storing an identifier of the selected first object into a first storage portion; second selection program code means for selecting a second object, different from the first object, from among the objects; second storage program code means for storing an identifier of the selected second object into a second storage portion; association program code means for associating the identifier of the first storage portion with the identifier of the second storage portion so that association of the identifiers of the first and second objects is obtained; and output program code means for outputting a tree-structured diagram representing the association of the objects, based on the association of the identifiers.

According to the tree-structured diagram output method of the present invention, the tree-structured diagram that represents the association of objects can be created efficiently, and it is possible to easily respond to the renewal and the reuse of a previously created tree-structured diagram when necessary.

### BRIEF DESCRIPTION OF THE DRAWINGS

Other objects, features and advantages of the present invention will be apparent from the following detailed description when read in conjunction with the accompanying drawings.

FIG. 1 is a block diagram of a computer system which is embodied according to the present invention.

FIG. 2 is a diagram showing the data stored in an object storage portion of an external storage device in the computer system of FIG. 1.

FIG. 3 is a diagram showing the data stored in a used-ID storage portion of the external storage device in the computer system of FIG. 1.

FIG. 4 is a diagram showing a tree-structured diagram which represents the association of technical subject and its solution means.

FIG. 5 is a diagram showing a property setting screen.

FIG. 6 is a flowchart for explaining a registration procedure according to a first preferred embodiment of the tree-structured diagram output method of the invention.

FIG. 7 is a flowchart for explaining an ID assignment procedure according to the tree-structured diagram output method of the present embodiment.

FIG. 8 is a flowchart for explaining an object association procedure according to the tree-structured diagram output method of the present embodiment.

FIG. 9 is a diagram for explaining a grouping procedure according to a second preferred embodiment of the tree-structured diagram output method of the invention.

FIG. 10 is a diagram showing a tree-structured diagram which represents the association of functional composition.

FIG. 11A and FIG. 11B are a flowchart for explaining a grouping and evaluation input procedure according to the second preferred embodiment of the tree-structured diagram output method of the invention.

FIG. 12 is a block diagram of a computer system which is embodied according to the present invention.

FIG. 13 is a diagram showing the data stored in an external information storing portion of an external storage device in the computer system of FIG. 12.

FIG. 14 is a diagram showing a query input screen.

FIG. 15 is a diagram showing a search result screen.

FIG. 16 is a diagram showing a patent information editing screen.

FIG. 17 is a diagram showing a search result screen after a patent kind is set.

FIG. 18 is a flowchart for explaining a patent information processing procedure according to a third preferred embodiment of the tree-structured diagram output method of the invention.

### DETAILED DESCRIPTION OF PREFERRED EMBODIMENTS

A description will now be provided of preferred embodiments of the present invention with reference to the accompanying drawings.

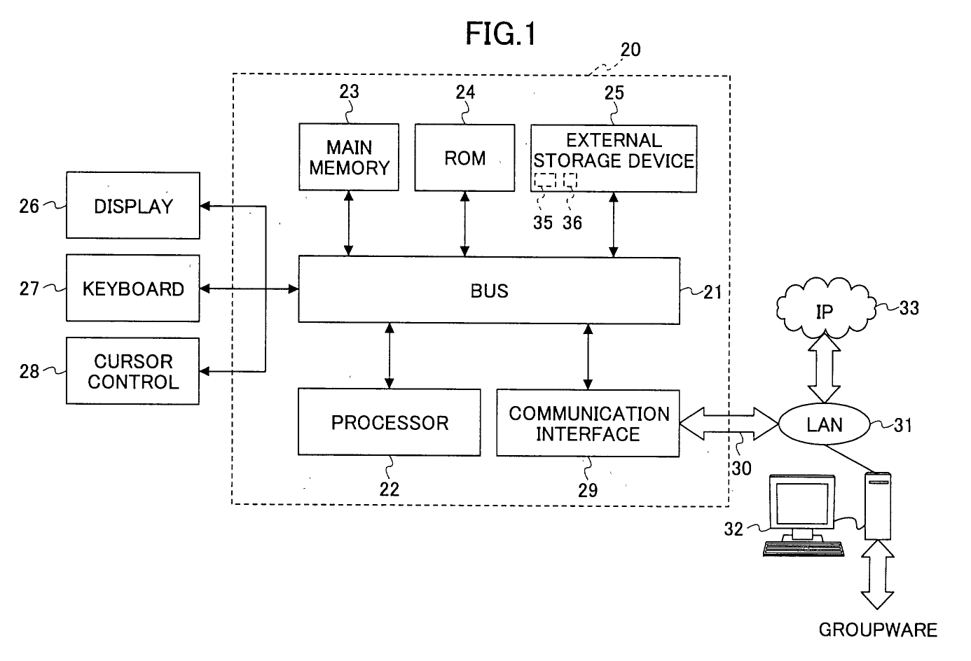

FIG. 1 shows a computer system which is embodied according to the present invention.

As shown in FIG. 1, the computer system 20 is equipped with the processor 22, the main memory 23, the ROM (read-only memory) 24, the external storage 25, and the communication interface 29, and these elements are interconnected by the bus 21. The bus 21 of the computer system 20 is connected with the display 26, the keyboard 27, and the cursor control 28. Furthermore, the communication interface 29 is connected to the LAN 31 through the network link 30. The LAN 31 is connected to the server 32. Moreover, LAN 31 is connected to the IP network 33.

The processor 22 processes execution of the instruction codes which are stored in the main memory 23. The main memory 23 is a RAM or another dynamic storage device (for example, DRAM, SRAM, SDRAM, flash RAM). The main memory 23 stores the instruction codes executed by the processor 22 as well as other information. Moreover, the main memory 23 is used in order to store another intermediate information which is used as temporary variables by the processor 22 during the execution of the instruction codes.

The ROM 24 stores the instruction codes executed by the processor 22, as well as the static information. The ROM 24 may be another static storage device (for example, PROM (programmable ROM), EPROM (erasable PROM), EEPROM (electrically erasable PROM)).

The external storage device 25 is a storage device of the processor 22 that is provided outside the processor 22. The external storage device 25 may be a magnetic disk drive or an optical disk drive, and stores the information and the instruction codes. Furthermore, the computer system 20 may be equipped with the logical unit for a special purpose, or the logical unit which is capable of correction or reuse of the internal circuits thereof. The logical unit for the special purpose may be ASICs (application specific integrated circuits). The logical unit which is capable of correction or use of the internal circuits may be GAL (generic array of logic) or FPGAs (field programmable gate arrays) in which the reprogramming is possible.

Moreover, the computer system 20 may be equipped with another removable medium (for example, the compact disk, the tape, and the removable optical magnetic medium), a fixed high-density medium, a compact disc reader, a compact disc reader/writer, or a compact disc jukebox (not shown). These will respectively use an appropriate bus (for example, the SCSI (small computer system interface) bus, the enhanced IDE (integrated device electronics) bus, or the DMA (direct memory access) bus).

The display device 26 is provided for displaying the information to the user. The display device 26 is, for example, a CRT (cathode ray tube) display. The display device 26 may be controlled by the graphics card.

The keyboard 27 is an input device for inputting the command or other information by the user. The cursor control 28 is provided for selecting direction information and command selection to the processor 22, and for controlling movement of the cursor on the display device 26. The cursor control 28 may be, for example, the mouse, the trackball, or the cursor direction keys.

Furthermore, the computer system 20 may be connected with the printer (not shown). The printer may print output the data stored or generated by the computer system 20.

The computer system 20 performs part or all of the processing steps of the present invention when the processor 22 executes the instruction codes stored by the main memory 23 and the external storage 25. The instruction codes which are readable by another computer, such as the instructions codes stored in the external storage device 25, can be read from the external storage device 25 into the main memory 23. Moreover, the instruction codes mentioned above may be executed through the multiprocessing.

In order to embody the present invention, it may replace the above-mentioned instruction codes (the instruction codes of the software) with the electrical circuits of the hardware and the above-mentioned instruction codes.

As mentioned above, the computer system 20 is equipped with the computer-readable storage medium which can be read by a computer. The computer-readable storage medium is used in order to perform the processing related to the present invention. In the computer-readable storage medium of the computer system 20, the instruction codes, the data structure, the table, the record and other data which will be described below are stored.

The tree-structured diagram output method of the present invention is carried out by the software of the computer system 20 enabling it to converse with the user in order to make one or a plurality of devices carry out the functions in order to control the operations of the computer system 20. Such software is stored in one or a plurality of computer-readable storage media.

The above-mentioned software may include the driver, the operating system, the development tool, and the application software, but it is not limited to these elements. Furthermore, the computer-readable storage medium may store the program for performing part or all of the processing performed by one embodiment of the present invention in the case where the processing is distributed.

The computer codes used by one embodiment of the present invention may be based on any programming language, such as the script language. The script language, the interpreter, the dynamic link library, the Java, and the programming language near the machine language may be included, but it is not limited to these elements. Furthermore, the processing of the present invention may be performed dispersedly.

The computer-readable storage medium may be any medium that provides the instruction codes executed by the processor 22 and the data. The computer-readable storage medium may include the nonvolatile storage medium, the volatile storage medium, and the transfer medium, but it is not limited to these elements. The nonvolatile storage medium may include the optical disk, the magnetic disk, and the magneto-optic disk such as in the external storage device 25. The volatile storage medium may include a dynamic memory such as the main memory 23. The transfer medium may include the optical fiber containing the coaxial cable, the copper wire, and the wire that forms the bus 21. Moreover, the transfer medium may be the acoustic wave or light wave which is generated in the electric wave and infrared data communication.

The computer-readable storage medium may be, for example, the hard disk, the floppy disk, the tape, the magneto-optic disk, the PROM (EPROM, EEPROM, flash PROM), DRAM, SRAM and SDRAM or others, the compact disk (for example, CD-ROM) or the other optical media, the punch card, the paper tape, the hole pattern, or the subcarrier.

The computer-readable storage medium may be used for the execution of the instruction codes by the processor 22. For example, the instruction codes may be executed with the magnetic disk of the remote computer at first. In order to perform all or part of the present invention in the remote environment, the remote computer may load the instruction codes to the dynamic memory, and may transmit the instruction codes through the telephone line using the modem.

Moreover, the computer system 20 may be equipped with the modem and the infrared detector (not shown). In order that the modem may transmit and receive data via the telephone line and may change the data into the infrared signal, it is possible to use the infrared transfer equipment. The infrared transfer equipment is connected to the bus 21, and the infrared detector receives the data transmitted by the infrared signal, and outputs the data to the bus 21.

Moreover, the instruction codes which are received at the main memory 23 may be stored in the external storage device 25 arbitrarily before or after the execution of the instruction codes by the processor 22. The communication interface 29 provides the bi-directional data communication through the network link 30 connected to the local network (the LAN 31). For example, the communication interface 29 may be the network interface card.

The communication interface 29 may be an ADSL (asymmetrical digital subscriber line) card, an ISDN (integrated services digital network) card, or a modem which is provided for data communication with a public telephone network. Furthermore, the communication interface 29 may be formed with the wireless ring, and the communication interface 29 in such a case transmits and receives the electrical signal, the electromagnetic signal or the optical signal.

The network link 30 provides the data communication to another data station through the network. For example, the communication interface 29 is connected to the data station managed by the server 32 or the service provider through the network link 30 and the LAN 31.

In addition, the service provider offers data transmission services through the IP (Internet Protocol) network 33.

The electrical signal, the electromagnetic signal or the optical signal, which carries the digital data stream, is used for both the LAN 31 and the IP network 33. The signal through the various networks, the signal on the network link 30, and the signal through the communication interface 29 take the typical form of the subcarrier which transmits the information. The computer system 20 can transmit and receive data between the communication parties through the network, the network link 30, and the communication interface 29.

The groupware (for example, the NOTES (the tradename of Lotus Development Co. in the U.S.) is connected to the above-mentioned server 32. The groupware is a tool which raises the productivity of the whole group including not only the individuals but also two or more participants, and the groupware is defined as a computer system aiming at raising the productivity of the group and designed by considering the use of the computer system by the group including two or more members as a premise.

The groupware includes the address book which is used to manage the addresses of the persons inside and outside the company to whom the use is permitted, and the groupware can transmit the E-mail to the selected-address point by choosing a desired address from the address book.

Furthermore, the database which stores various information is also manageable on the groupware. For example, in case the E-mail is transmitted, the link with the arbitrary database can be attached, or various information as a bulletin board can be transmitted for the database.

Furthermore, a patent information retrieval system (not shown) is connected to the server 32. About the issue for which an application for patent is submitted, the patent information retrieval system provides the relevant information including the filing date of application, the priority date, the official communication date (the laying-open date, the publication date, the registration date, etc.), the applicant, the application number, the publication number, the registration number, the International Patent Classification, the keyword, etc., and can search the desired patent official report.

The processor 22 controls the data transmission and reception and executes the various programs. The respective programs executed by the processor 22 in the present embodiment constitute the identifier setting program code means, the 1st selection program code means, the 2nd selection program code means, the association program code means, the output program code means, the 1st assignment program code means, the 2nd assignment program code means, the 1st limitation program code means, the 2nd limitation program code means, the count program code means, and the determination program code means. The property registration program, the ID assignment program, the association program, etc. are stored in the main memory 23. By executing each of the above-mentioned programs, the processor 22 functions as each of the above-mentioned program code means. For example, the property registration program is the program executed by the processor 22 to register the property of the object. The ID assignment program is the program executed by the processor 22 to assign the ID to the object. The association program is the program executed by the processor 22 to associate the upper rank object and the lower rank object.

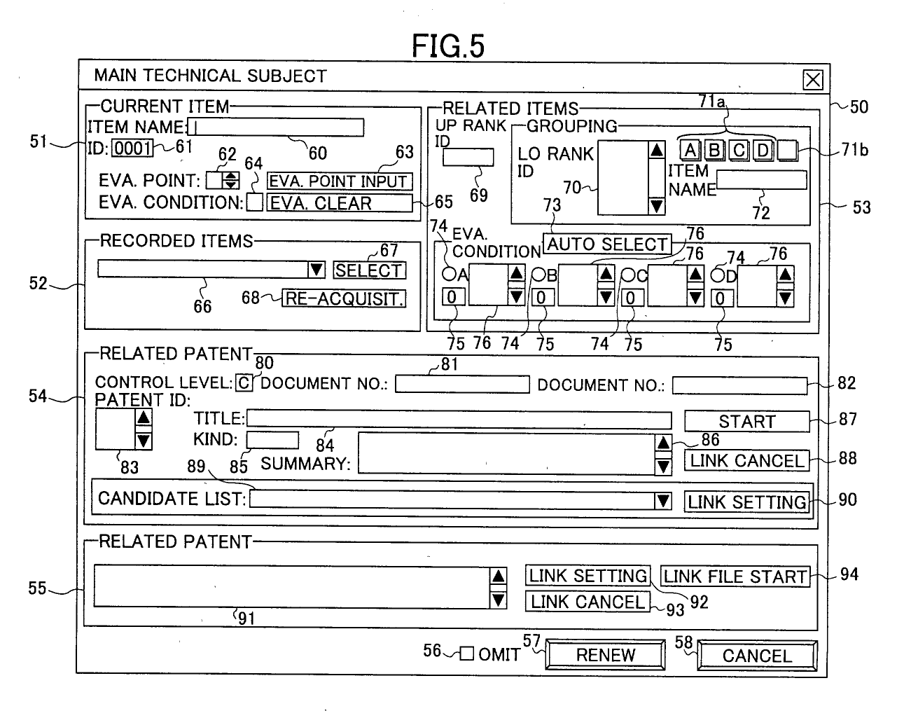

FIG. 4 shows a tree-structured diagram 40 which represents the association of technical subject and its solution means in the worksheet of the spreadsheet software displayed on the display device 26.

The external storage device 25 stores the worksheet of the spreadsheet software for displaying the tree-structured diagram 40 of FIG. 4. The worksheet of the spreadsheet software is arranged in rows and columns in the table formation. Each cell of the spreadsheet software worksheet is identified by the specified row and column one by one.

In the worksheet which is shown in the tree-structured diagram 40, the cell with which the object can be re-arranged is set up by the column sequence. That is, in the worksheet shown in FIG. 4, the cells contained in the 1st column, the 4th column, the 7th column and the 10th column (which correspond to the main technical subject 41, the solution means 42, the individual technical subject 43 and the solution means 44) can be re-arranged. The ruled line 45 for indicating the association of the objects is displayed on the cells other than the cells which can be re-arranged.

The ID which is specific to each of the objects is assigned to every object as the identifier that allows the processor 22 to discriminate the object from the other objects. In the worksheet which indicates the tree-structured diagram 40, the object name and ID are displayed with respect to each of the respective objects.

The property information can be set with respect to each of the objects in the worksheet. The property information is specified by the ID of the object concerned. The property information for every object is stored in the object storage portion 35 of the external storage device 25.

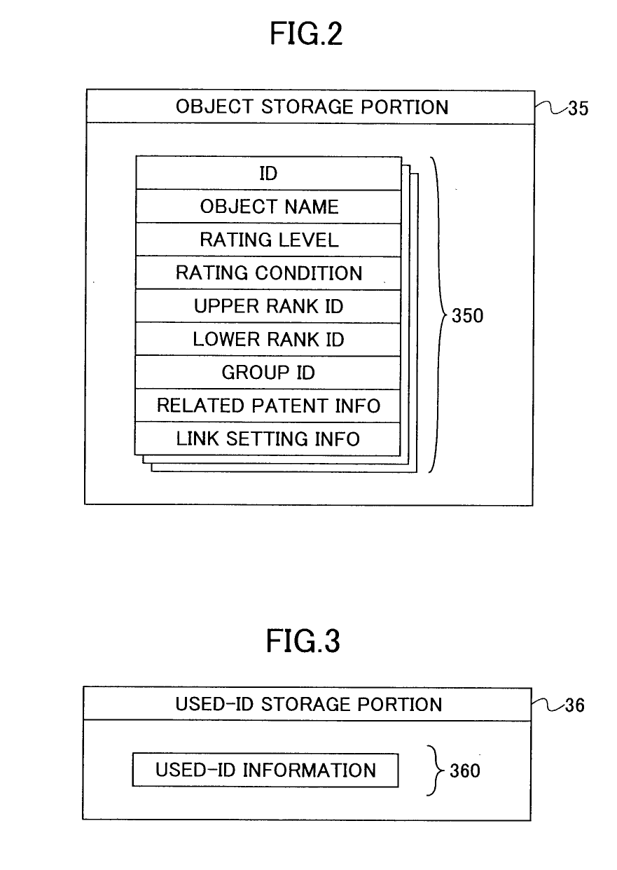

FIG. 2 shows the data stored in the object storage portion 35 of the external storage device 25 in the computer system of FIG. 1.

As shown in FIG. 2, the object storage portion 35 stores the object information 350 for every ID. The object information 350 is constituted by the property information including the ID, the object name, the rating level, the rating conditions, the upper rank ID, the lower rank ID, the group identifier, the related patent information, and the link setting information. The object storage portion 35 constitutes the 1st storage portion by storing the ID of the above-described object information 350. The object storage portion 35 constitutes the 2nd storage portion by storing the upper rank ID or the lower rank ID. The object storage portion 35 constitutes the rating level storage portion by storing the above-described rating level.

The object name in the object information 350 is the name of the object that is used by the user for the discrimination of the object concerned. The evaluating point (0-3) for the contents of the object indicates the rating level in the object information 350. The rating conditions are used when using the rating of the lower rank object as the rating of the object concerned. The upper rank ID is the ID of the object of the upper rank one-level higher than the rank of the object concerned.

The lower rank ID in the object information 350 is the ID of the object of the lower rank one-level lower than the rank of the object concerned. The group identifier indicates the identification of the group of the objects of the lower rank related to the object concerned, and the group of the objects is divided into A, B, C and D in the present embodiment. The related patent information is the information concerning the related patent. The link setting information indicates the location of an external database where the information related to the object concerned is stored.

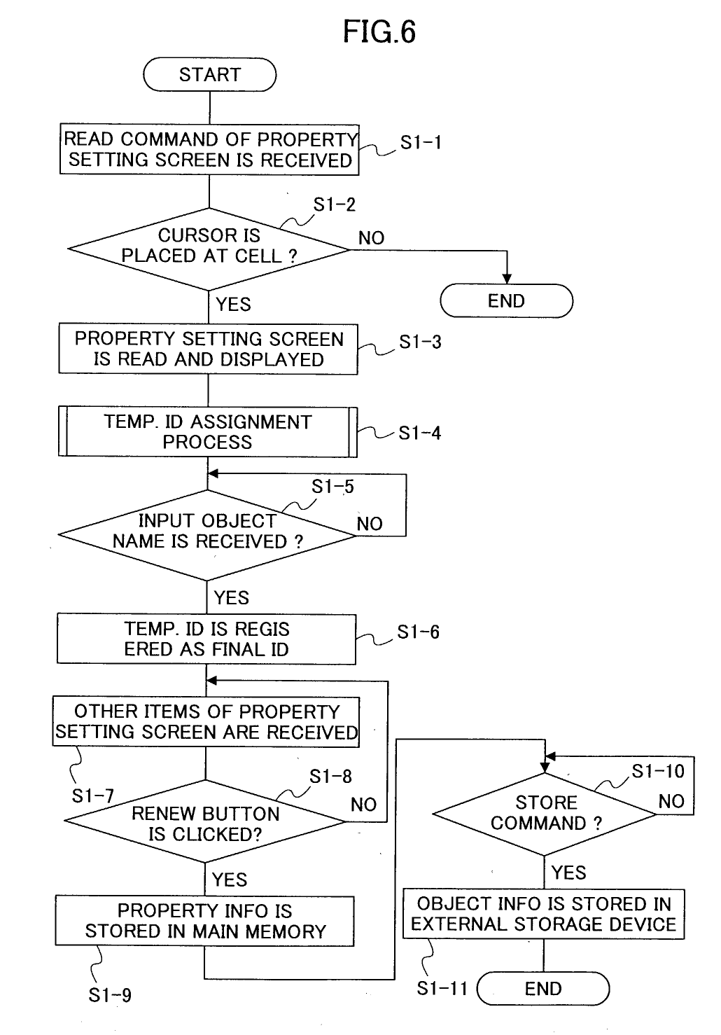

As for the object information 350, the object name, the rating level, the rating conditions, the upper rank ID, the lower rank ID, the group identifier, the related patent information and the link setting information are set up and inputted by the user using keyboard 27 while viewing the property setting screen 50 of FIG. 5 displayed on the display device 26.

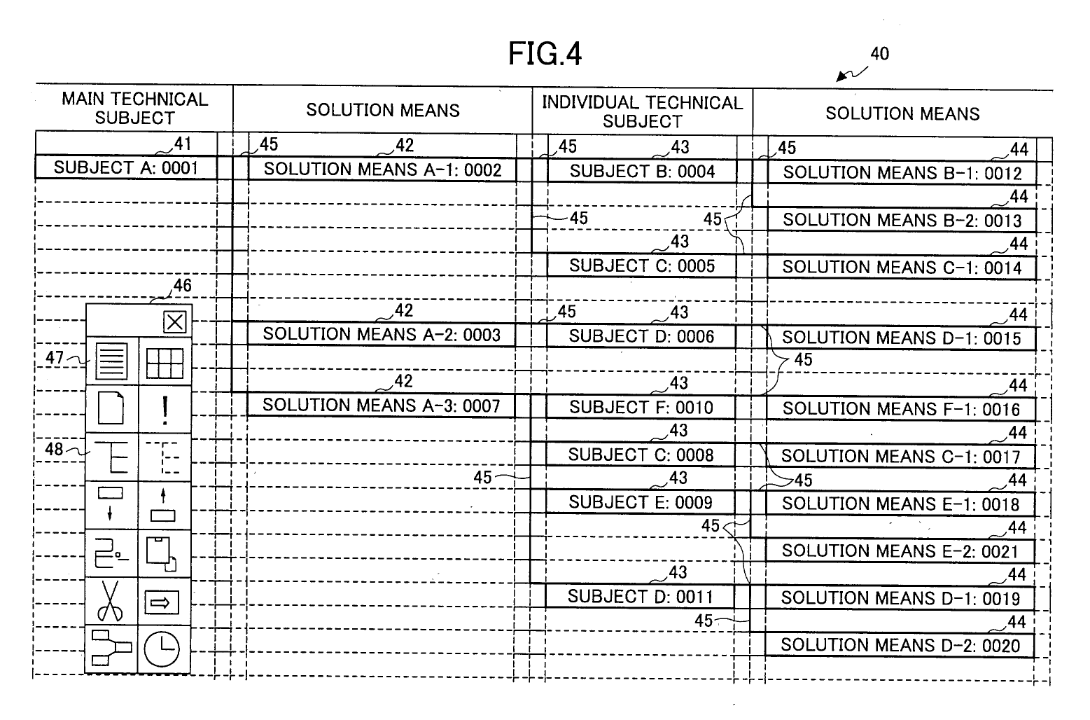

The external storage device 25 further includes the used-ID storage portion 36. FIG. 3 shows the data stored in the used-ID storage portion 36 of the external storage device 25 in the computer system of FIG. 1. As shown in FIG. 3, the used-ID storage portion 36 stores the largest number (ID) among the used IDs as the used-ID information 360.

The worksheet, the object information 350 and the used-ID information 360 which are stored in the external storage device 25 are read out and stored into the main memory 23. As described above, FIG. 4 shows a tree-structured diagram 40 which represents the association of technical subject and its solution means in the worksheet of the spreadsheet software displayed on the display device 26. The processor 22 causes the display device 26 to display the tree-structured diagram 40 of FIG. 4 in accordance with the output command which is inputted by using the keyboard 27 or the cursor control 28.

In the tree-structured diagram 40 of FIG. 4, the objects are the technical subjects and the solution means thereof. In the present embodiment, the tree-structured diagram 40 represents the association of the technical subjects and the solution means as the objects including the 1st column, the 4th column, the 7th column and the 10th column of the worksheet of the spreadsheet software (which correspond to the main technical subject 41, the solution means 42, the individual technical subject 43 and the solution means 44).

In the tree-structured diagram 40 of FIG. 4, the upper rank object and the lower rank object are associated by the ruled lines 45, and such association of the objects is displayed with the tree-structured diagram 40. For example, the object of the 1st hierarchical layer (the main technical subject 41) and the objects of the 2nd hierarchical layer (the solution means 42) are connected together by the ruled lines 45.

The object name and the ID of the respective objects are indicated in the format of “the object name: the ID”. In the present embodiment, the object name of the main technical subject 41 is “Subject A” and the ID of the main technical subject 41 is “0001”.

As the lower rank object related to the object of the “Subject A:0001”, the solution means 42 is indicated in the format of “the solution means A-1:0002”, the “solution means A-2:0003”, and the “solution means A-3:0007”), respectively. That is, “0002”, “0003”, and “0007” are set to the lower rank IDs of the object information 350 with respect to the object the upper rank ID of which is “0001.”

Moreover, “0001” is set to the upper rank ID of the object information 350 with respect to the objects the lower rank IDs of which are “0002”, “0003” and “0007”.

Similarly, the individual technical subjects 43 (“the subject B:0004”, the “subject C:0005”, etc.) are indicated as the lower rank objects associated when the object of the “solution means A-1:0002” of the solution means 42 is considered as the upper rank object. As the lower rank object associated considering the object of the “subject B:0004” of the individual technical subjects 43 as the upper rank object, the solution means 44 (“the solution means B-1:0012”, and “the solution means B-2:0013”) is displayed. Thus, the association of the technical subject 1 and the solution means is expressed by the tree-structured diagram 40 in which the technical subjects and the solution means appear.

According to the above-mentioned group identifier, the classification-by-color indication of the frame line of the cell which displays each object is given. That is, the frame line is expressed as the different color for every group of A, B, C and D. The rating conditions are shown by the color of the ruled line 45 on the left-hand side of the cell which displays each object. That is, for example, when the group “A” is set up as the rating conditions for a certain object, the ruled line 45 on the left-hand side of the cell which displays the object which belongs to the “A” group among the lower rank objects which make the object the upper rank object is displayed in red.

FIG. 5 shows a property setting screen 50. The property information of each object, which includes the main technical subject 41, the solution means 42, the individual technical subject 43, and the solution means 44, is set up by using the property setting screen 50 of FIG. 5.

When the object in the worksheet of the tree-structured diagram 40 is selected and the edit button 47 in the control panel 46 is clicked, the property setting screen 50 is displayed.

As shown in FIG. 5, the current item setting section 51, the registration item setting section 52, the related item setting section 53, the related patent setting section 54, and the link file setting section 55 are formed in the property setting screen 50. Moreover, the lower part of the property setting screen 50 includes the registration deletion check button 56, the renewal button 57, and the cancellation button 58.

The current item setting section 51 performs the display and the input with respect to the object set as the cell chosen by the cursor control 28 in the worksheet which indicates the tree-structured diagram 40. The current item setting section 51 has the subject-name input box 60, the ID display 61, the evaluating point input box 62, the evaluating point input button 63, the rating condition input box 64, and the rating clear button 65. The evaluating point input box 62 contains the evaluating point 0-3 (0: no evaluation, 1: the main problem, 2: the problem, 3: no problem) that can be inputted by the user. The evaluating point is inputted manually. Moreover, when the rating conditions are set up by the user so that the lower rank ID may exist, the evaluating point is automatically displayed on the evaluating point input box 62 reflecting the evaluating point of the lower rank ID.

The evaluating point input button 63 is clicked when inputting the evaluating point into the evaluating point input box 62 manually. The evaluation clear button 65 is clicked when clearing the value set as the evaluating point input box 62. When the lower rank ID exists, the use of the evaluation clear button 65 is inhibited, and the clearing of the evaluating point is forbidden. The ID, which is registered as the temporary ID or the final ID assigned, is indicated in the ID display portion 61.

The registration item setting section 52 includes the registration item selection top-down list 66, the selection button 67, and the re-acquisition button 68-. In the worksheet which indicates the tree-structured diagram 40, the registration item setting section 52 is used in order to display and choose the object by which the past registration is carried out. The item to display is registered beforehand and the item seen registered is displayed in the registration item selection top-down list 66. If the item is chosen and the selection button 67 is clicked by the registration item selection top-down list 66, the selected item will be displayed on the subject-name input box 60. The re-acquisition button 68 is clicked when reading again the registered item displayed on the registration item selection top-down list 66.

The related item setting section 53 has the upper rank ID input box 69, the grouping setting section, and the rating conditioning section. When the object of the current item is made into the lower rank object, the ID of the upper rank object for the lower rank object is automatically inputted into the upper rank ID input box 69 to the lower rank object. The number of the ID which can be inputted into the upper rank ID input box 69 is one.

When the object of the current item is the object (main technical subject 41) of the most significant, the upper rank ID cannot be set up.

The grouping setting section has the lower rank ID input section 70, the group sign selection button 71a, the group release button 71b, and the subject-name display 72. When the object of the current item is made into the upper rank object, the ID of the lower rank object for the upper rank object is automatically inputted into the lower rank ID input section 70 to the upper rank object. Two or more IDs can be inputted into the lower rank ID input section 70.

If the ID is chosen in the lower rank ID input section 70, the object name of the lower rank ID chosen as the subject-name display 72 will be displayed, and the ID is set as the group composition ID input section 76 the group of which corresponds if the group sign selection button 71a is clicked.

If the ID is chosen in the lower rank ID input section 70 and the group release button 71b is clicked, the group setup will be canceled with respect to the ID concerned.

The rating conditioning section has the automatic selection button 73, the group selection radio button 74, the evaluating point input box 75, and the group composition ID input section 76. The minimum value of the evaluating points of the objects which constitute the group concerned is displayed in the evaluating point input box 75.

If the automatic selection button 73 is clicked, the group selection radio button 74 of the group which has the minimum value among the evaluating points of the evaluating point input box 75 of each group will be automatically selected.

The group selection radio button 74 is checked when choosing the group manually as the rating conditions. That is, the check of one of the group selection radio buttons 74 indicates the selected group (A, B, C, or D) on the rating condition input box 64.

The related patent setting section 54 has the management level display 80, the official report number display 81, the applicant display 82, the patent ID selection section 83, the invention name display 84, the patent classification display 85, the summary display 86, the patent retrieval-system start button 87, the link deletion button 88, the candidate list selection section 89, and the link setup key 90.

The related patent setting section 54 is used when the above-mentioned patent retrieval system is accessed and the management of the related patent information is needed.

The patent retrieval-system start button 87 is clicked when starting the above-mentioned patent retrieval system. The patent ID by which the link setup is carried out with the object of the current item is displayed in the patent ID selection section 83.

If the patent ID is chosen at the patent ID selection section 83, the management level with respect to the patent information, the official report number, the applicant, the invention name, patent classification, and the summary will be displayed in the management level display 80, the official report number display 81, the applicant display 82, the invention name display 84, the patent classification display 85, and the summary display 86.

The link setup key 90 is clicked when deleting the link with respect to the patent information chosen in the patent ID selection section 83.

On the other hand, the list of patent information which serves as the candidate set up in the above-mentioned patent retrieval system is displayed in the candidate list selection section 89.

If the patent information is chosen in the candidate list selection section 89 and the link setup key 90 is clicked, the link setup will be carried out with respect to the association of the object of the current item and the selected patent information. The patent ID with respect to the patent information is displayed in the patent ID selection section 83.

The link file setting section 55 has the link file display 91, the link setup key 92, the unlinking button 93, and the link file start button 94. The link file setting section 55 is used when managing the link file. The file by which the link setup is carried out with the object of the current item is displayed in the link file display 91.

If the file is chosen by the link file display 91 and the link file start button 94 is clicked, the selected file will be read and the selected file will be displayed.

The link setup key 92 is used when carrying out the link setup of the file relevant to the object of the current item. The unlinking button 93 is used when canceling the link with respect to the file chosen by the link file display 91.

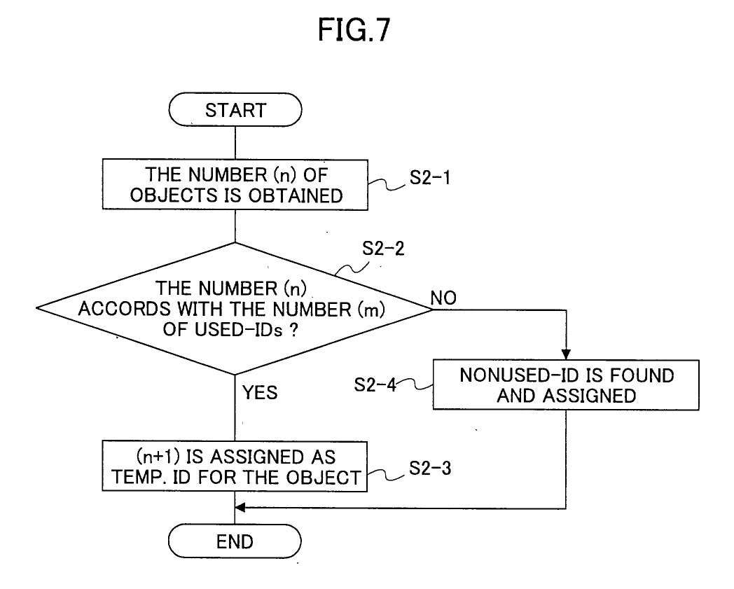

Next, a description will be given of a registration procedure which is performed by the computer system of FIG. 1, with reference to FIG. 6. FIG. 6 shows the registration procedure according to the first preferred embodiment of the tree-structured diagram output method of the present invention.

As shown in FIG. 6, the read command is given in the above-mentioned property setting screen 50 first (S1-1). In the worksheet which indicates the tree-structured diagram 40, the cell is chosen with the cursor control 28 and the edit button 47 of the control panel 46 is clicked.

After the step S1-1 is performed, the processor 22 determines whether the cursor is placed at a predetermined location of the worksheet (cell) (S1-2). The predetermined location of the worksheet is called the cell, and it corresponds to one of the cells which can be re-arranged, and the cell to which other objects are not set.

When there is no cursor on the cell which can be re-arranged (NO at S1-2), the processor 22 ends the processing.

On the other hand, when the cursor is on the cell which can be re-arranged (YES at S1-2), the processor 22 reads the information for displaying the property setting screen 50 from the main memory 23, and displays on the display device 26 the property setting screen 50 of FIG. 5 (S1-3).

The processor 22 performs the temporary ID assignment process which assigns the temporary ID with respect to the target object (S1-4). The processor 22 performs the temporary ID assignment process according to the ID assignment program.

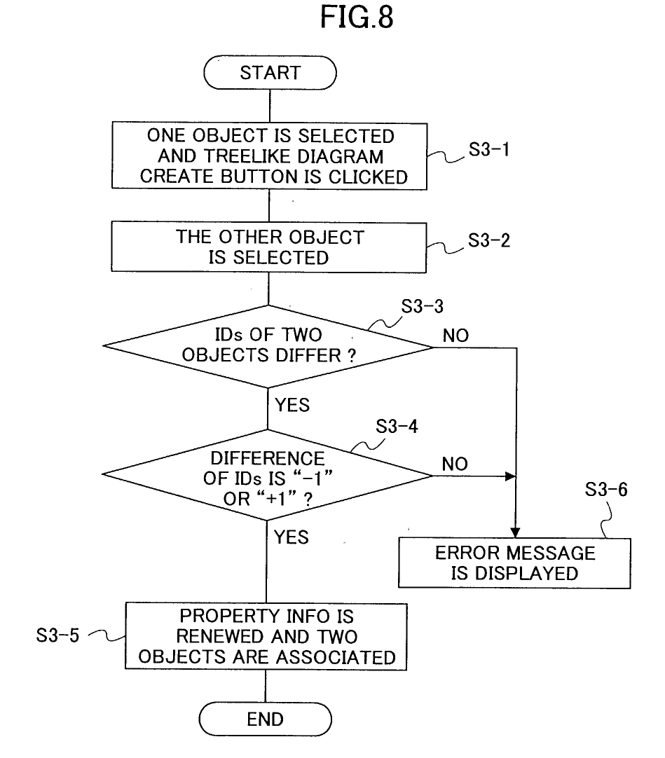

FIG. 7 shows the temporary ID assignment procedure according to the tree-structured diagram output method of the present embodiment.

As shown in FIG. 7, the processor 22 counts the number (n) of the objects stored in the object storage portion 35 (S2-1).

The processor 22 extracts the used-ID information 360 from the used-ID storage portion 36 of the external storage 25, and causes the main memory 23 to store the number (m) of the used ID.

The processor 22 determines whether the counted number of the objects (n) matches with the number of the used ID (m) (S2-2).

When the result at the step S2-2 is affirmative, the processor 22 assigns the number (n+1) as the temporary ID of the object (S2-3), and ends the procedure of FIG. 7. In this case, the processor 22 updates the number of the used ID in the main memory 23 such that the assigned temporary ID (n+1) of the main memory 23 is the ID having the largest number among the used IDs.

When the result at the step S2-2 is negative, the processor 22 searches for the vacant ID in the order from the smaller value, and assigns the first discovered vacant ID as the temporary ID of the object (S2-4), and ends the procedure of FIG. 7. The assigned temporary ID is displayed in the ID display 61 of the property setting screen 50.

Referring back to FIG. 6, when the user inputs the object name to the subject-name input box 60 of the current item setting section 51 and the processor 22 receives the same (YES at S1-5), the processor 22 registers the ID into the object storage portion 35 by considering as the final ID the temporary ID assigned before (S1-6). At this time, the processor 22 updates the used-ID storage portion 36 by considering as the ID information 360 the number of the used ID stored to the main memory 23.

When the object name is not inputted into the subject-name input box 60 (NO at S1-5), the processor 22 requests the user of the input of the subject name and the step S1-5 is repeated. In this manner, the ID is registered into the object storage portion 35 when the processor 22 receives the object name inputted by the user.

After the input of the object name is performed, the user clicks the renewal button 57 by the cursor control 28. When the input of other items of the property setting screen 50 is performed by the user, the processor 22 receives the relevant information (S1-7) and the input is completed. The processor 22 determines whether the renewal button 57 is clicked by the user (S1-8).

When the result at the step S1-8 is negative, the control is returned to the step S1-7 and the steps S1-7 and S1-8 are repeated.

When the result at the step S1-8 is affirmative (the renewal button 57 is clicked) and the input of other items is completed, the processor 22 stores the property information in the main memory 23 (S1-9).

The processor 22 performs the above-described property registration procedure in accordance with the property registration program.

After the step S1-9 is performed, the processor 22 determines whether it receives the store command input by the user using the keyboard 27 or the like (S1-10).

When the user inputs the store command related to the object information 350 (YES at S1-10), the processor 22 causes the external storage device 25 to store the worksheet and the object information 350 therein (S1-11). Otherwise the control of the processor 22 is returned to the step S1-10, and the processor 22 is set in a waiting condition for performing the storage of the worksheet and the object information 350 to the external storage device 25 until the store command is inputted by the user.

With respect to the registered object information, the processor 22 further carries out the renewal registration of the property information. In this case, the property setting screen 50 is displayed with respect to the registered object, and the renewal registration of the property information is performed in accordance with the steps S1-7 to S1-10 with respect to the object concerned.

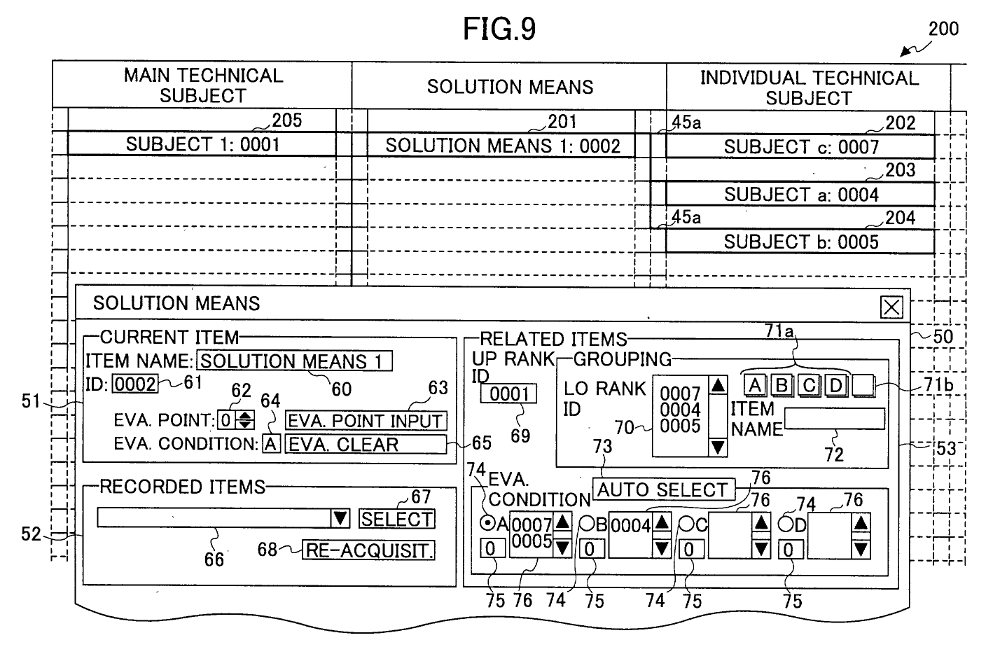

Next, a description will be given of the object association procedure for associating the registered object with other objects with reference to FIG. 8.

FIG. 8 shows an object association procedure according to the tree-structured diagram output method of the present embodiment. The processor 22 performs the object association procedure as shown in FIG. 8 in accordance with the object association program.

As shown in FIG. 8, at a start of the object association procedure, the user selects one object (the first object) in the worksheet of the tree-structured diagram 40 displayed on the display device 26 by using the cursor control 28, and clicks the treelike diagram creation button 48 of the control panel 46 (S3-1). In this step S3-1, the processor 22 detects the ID of the selected first object.

After the step S3-1 is performed, the user continuously selects the other object (the second object) in the worksheet of the tree-structured diagram 40 by using the cursor control 28, and performs the completion operation of selection (for example, the double click). Then, the processor 22 detects the ID of the selected second object (S3-2).

After the step S3-2 is performed, the processor 22 determines whether the IDs of the two selected objects differ from each other (S3-3).

When the IDs of the two selected objects are the same (NO at S3-3), the processor 22 displays the error message on the display device 26, indicating that the user's selection of the objects is wrong (S3-6), and ends the procedure of FIG. 8.

On the other hand, when the IDs of the two selected objects differ from each other (YES at S3-3), the processor 22 determines whether the difference of the IDs of the selected objects is “−1” or “+1” (S3-4). When the result at the step S3-4 is negative, the processor 22 displays the error message on the display device 26, indicating that the user's selection of the objects is wrong (S3-6), and ends the procedure of FIG. 8.

When the result at the step S3-4 is affirmative, the processor 22 renews the upper rank ID and the lower rank ID of the property information 350 (stored in the object storage portion 35) of the selected objects (S3-5). That is, with respect to the selected objects, the inputted upper rank ID and lower rank ID are set up as the upper rank ID and lower rank ID of the object information 350, and it is stored in the main memory 23 (S3-5). Furthermore, with respect to the object of the inputted upper rank ID, the ID of the selected object is set up as the lower rank ID of the object information 350, and it is stored in the main memory 23. Moreover, with respect to the object of the inputted lower rank ID, the ID of the selected object is set up as the upper rank ID of the object information 350, and it is stored in the main memory 23.

And, when the user inputs the store command, the processor 22 stores the information concerning the association of the objects, stored in the main memory 23, into the object storage portion 35 of the external storage device 25. With the storing operation according to the input store command, the processor 22 creates automatically a new ruled line 45 which connects the two objects in the worksheet of the tree-structured diagram 40.

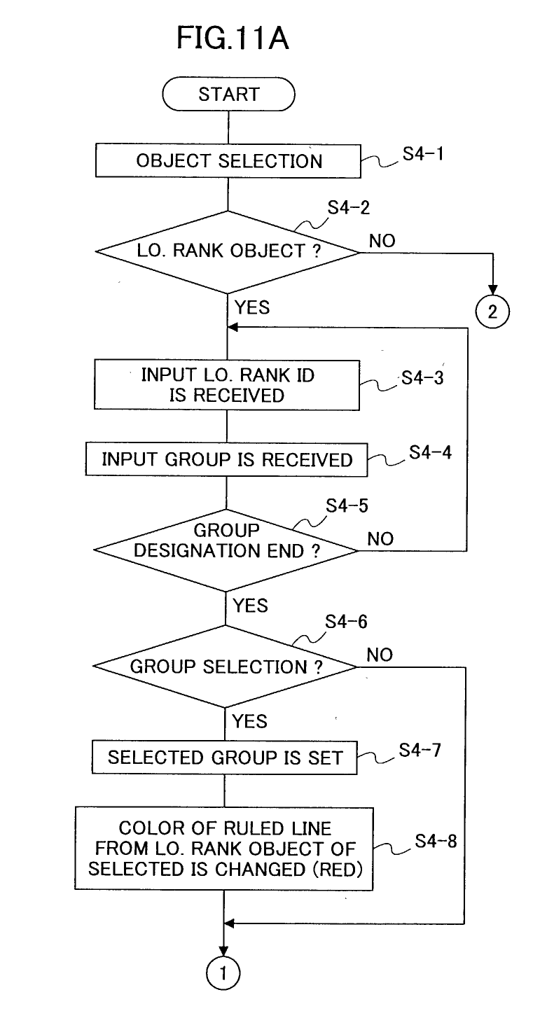

In the above-described embodiment, the tree-structured diagram representing the association of technical subject and its solution means is created according to the tree-structured diagram output method of the present invention. However, the present invention is not limited to this embodiment. For example, according to the tree-structured diagram output method of the present invention, it is also possible to create a tree-structured diagram which represents the association of functional composition as shown in FIG. 10. When displaying the tree-structured diagram of FIG. 10, it is possible to develop the functions to the 1st level function, the 2nd level function, the 3rd level function, etc.

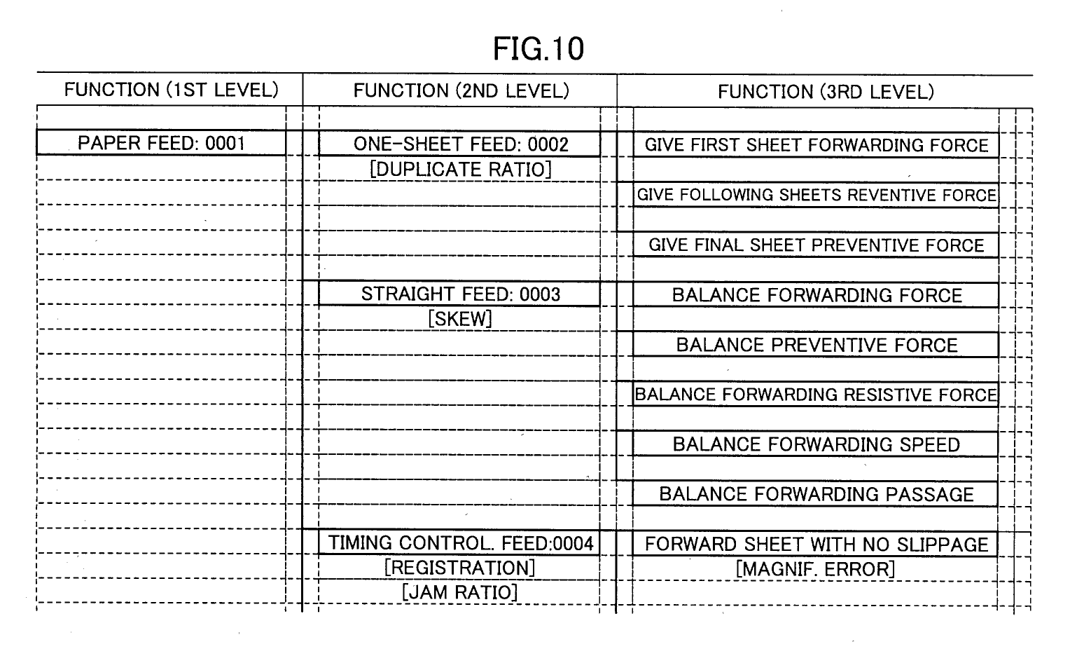

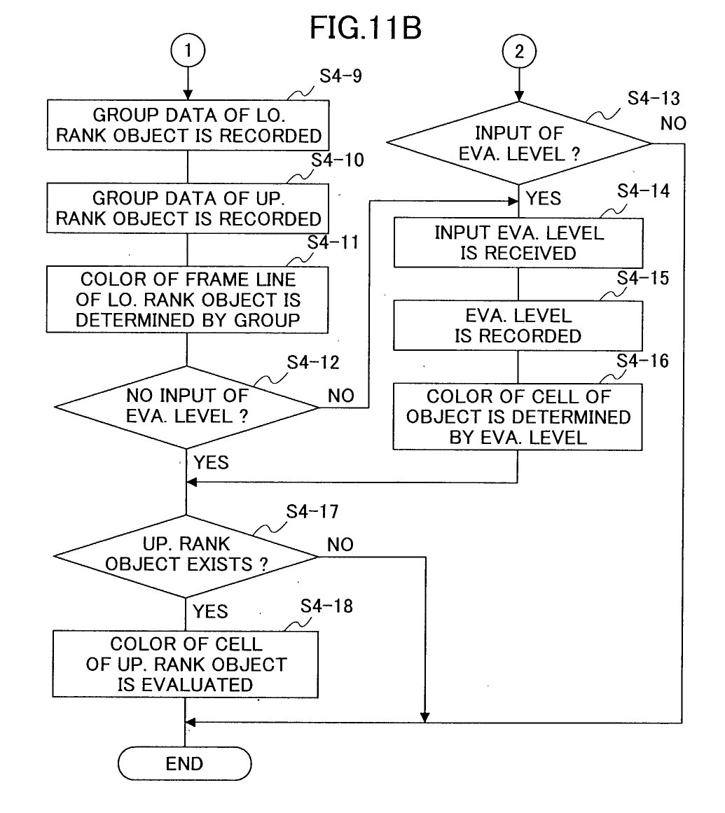

Next, a description will be provided of a second preferred embodiment of the tree-structured diagram output method of the invention with reference to FIG. 9, FIG. 11A and FIG. 11B.

FIG. 9 shows a grouping procedure according to the second preferred embodiment of the tree-structured diagram output method of the invention. FIG. 11A and FIG. 11B show a grouping and evaluation input procedure according to the second preferred embodiment of the tree-structured diagram output method of the invention.

In the present embodiment, the grouping procedure is performed with respect to the lower rank object associated with the upper rank object. Moreover, according to the rating conditions mentioned later, the rating level is set up with respect to each object. The processor 22 creates and outputs the tree-structured diagram showing the results of the grouping and evaluation input procedures.

When the group specification is performed as the group part injury line crack and rating conditions with respect to the lower rank objects, the lowest value is reflected in the upper rank object among the rating levels of the objects belonging to the group. This processing is performed according to the grouping processing program.

In FIG. 9, the tree-structured diagram 200 is displayed in the worksheet of the spreadsheet software. Furthermore, the property setting screen 50 with respect to the object of the “solution means 1:0002” in the tree-structured diagram 200 is displayed in an overlapping manner.

As shown in FIG. 11A, the user chooses the object in the worksheet of the tree-structured diagram 200, and the processor 22 receives the selection (S4-1). In this example, the user chooses the object 201 of “the solution means 1:0002” and displays the property setting screen 50 with respect to the selected object by using the control panel 46 (not shown in FIG. 9).

The processor 22 determines whether the selected object has the lower rank object (S4-2). That is, the processor 22 detects whether any ID is set in the lower rank ID input section 70. In this example, “0007”, “0004” and “0005” are set in the lower rank ID input section 70 respectively.

When the ID is set in the lower rank ID input section 70 (i.e., when there is the lower rank object), the user can specify the lower rank ID in the lower rank ID input section 70. The processor 22 receives the specified lower rank ID (S4-3). In this example, the user chooses “0007” in the lower rank ID input section 70, and the processor 22 receives this.

When the input group is specified with respect to the object of the lower rank ID selected by the user, the processor 22 receives the input group (S4-4). In this example, if the user clicks the group sign selection button 71a of the A group, the processor 22 receives “A” as the group designation.

The processor 22 sets “0007” as the group composition ID input section 76 of the A group. When the group specification of all the lower rank objects is not completed (NO at S4-5), the processing of the above-mentioned steps S4-3 and S4-4 is repeated. In this example, the same operation is performed, and “0005” is set as the A group and “0004” is set as the B group.

When the group specification is completed (YES at S4-5), the control of the processor 22 is transferred to the processing of group selection.

The user performs the group selection by choosing one with respect to the A, B, C, and D groups in the group selection radio buttons 74. In this example, the user chooses the group selection radio button 74 of the A group. The processor 22 determines whether group selection is performed (S4-6).

When the group selection is carried out, the processor 22 sets the group designation of the group chosen by the user in the rating condition input box 64 (S4-7). In this example, “A” is set in the rating condition input box 64.

The processor 22 changes the color of the horizontal ruled line 45a, coming out of each of the lower rank objects in the tree-structured diagram 200, to red according to the setup of the group selection (S4-8). That is, the horizontal ruled lines 45a of the cells on the left-hand side of the objects 202 and 204 of the “subject c:0007” with which the grouping is carried out, and “the subject b:0005” is changed into A group by red.

The processor 22 stores the group attribute data of each of the lower rank objects of the selected object (S4-9). Namely, with respect to the selected object, the processor 22 associates the group designation, which is the group attribute of each lower rank object, with the lower rank ID, and stores the association of the group designation and the lower rank ID in the object storage portion 35.

Moreover, the processor 22 stores the upper rank group attribute data with respect to each of the lower rank objects (S4-10). That is, with respect to each of the lower rank objects, the processor 22 associates the group designation, which is the group attribute of the upper rank object, with the upper rank ID, and stores the association of the group designation and the upper rank ID in the object storage portion 35.

Next, the processor 22 classifies the color of the frame line of each lower rank object according to the group with respect to the tree-structured diagram 200 in the worksheet displayed on the display device 26 (S4-11). That is, the color of the frame line is classified into purple, green, brown, and pink with respect to each of the A, B, C, and D groups. In this example, the frame line of the objects 202 and 204 of the “subject c:0007” and the “subject b:0005” with which the grouping procedure is carried out is set to purple for the A group, and it is displayed. Moreover, the frame line of the object 203 of the “subject a:0004” with which the grouping procedure is carried out is set to green for the B group, and it is displayed.

The user inputs the rating level manually to the evaluating point input box 62 when it is decided that the rating level is inputted manually. As mentioned above, the manual input of the rating level to the evaluating point input box 62 is inhibited if the object concerned has the lower rank ID and the rating conditions are set up.

In this example, the lower rank IDs “0007”, “0004” and “0005” exist, and, among such IDs, the grouping of “0007” and “0005” is performed as being set to the A group, and the group selection radio button 74 is checked with respect to the A group. Hence, the manual input of the rating level to the evaluating point input box 62 is inhibited in this example. In this case, the rating level set up with respect to the lower rank object is reflected. At this step, it is assumed that the rating level is not set up with respect to the lower rank object.

The processor 22 determines whether the rating level is manually inputted in the evaluating point input box 62 (S4-12). In this example, as mentioned above, since the rating level is not manually inputted in the evaluating point input box 62, the processor 22 determines whether the upper rank object exists in the selected object (S4-17).

When the upper rank object exists in the selected object, the rating level of the selected object is reflected, and the processor 22 evaluates the color of the cell of the upper rank object in the tree-structured diagram 200 (S4-18). After the step S4-18 is performed, the processor 22 ends the processing of FIG. 11B.

In this example, the rating level of the selected object is “O” (no evaluation). In addition, when the rating level is “O” (no evaluation) in the tree-structured diagram 200, the color of the cell indicating the selected object is set to white and it is displayed. For this reason, in the tree-structured diagram 200, the cell of the selected object 201 is white and it is displayed.

In the color of the cell of the upper rank object, the cell of the upper rank object 205 of the “subject 1:0001” is also white, and it is displayed.

On the other hand, the processor 22 ends the processing when the upper rank object does not exist in the selected object (NO at S4-17).

When the user chooses the object 202 of “subject c:0007” next, the processor 22 receives the selected object again (S4-1). The user displays the property setting screen 50 with respect to the selected object by using the control panel 46.

Since the lower rank object does not exist in the object 202 of “subject c:0007” for this case (NO at S4-2), the user decides whether the rating level with respect to the selected object is inputted or not. When it is decided that the inputting of the rating level is performed, the rating level is inputted to the evaluating point input box 62 by the user.

In this example, the evaluating point input button 63 is clicked and “3” (no problem) is inputted to the evaluating point input box 62. The processor 22 determines whether the rating level is manually inputted to the evaluating point input box 62 (S4-13).

When the rating level is not inputted manually, the processor 22 ends the procedure of FIG. 11B.

In this example, since the manual input of the rating level is performed, the processor 22 receives the input rating level (S4-14), and stores the received rating level in the object storage portion 35 (S4-15). Thereby, “3” (no problem) is set up for the ID “0007” as the rating level of the object information 350.

The processor 22 performs the color classification according to the received rating level with respect to the cell of the object in the tree-structured diagram 200 (S4-16). That is, the processor 22 classifies the color of the cell of the object based on the setup of the rating level of the object storage portion 35.

In the present embodiment, the color of the cell of each object is classified into white, purple, yellow and green for the respective rating levels “0” (no evaluation), “1” (significant problem), “2” (problem) and “3” (no problem), respectively. The cell of each object is displayed in the color determined by the processor 22.

That is, the cell of the object 202 of “subject c:0007” to which the rating level “3” (no problem) is set is displayed in green.

Next, the processor 22 determines whether the upper rank object exists in the selected object 202 of “subject c:0007” (S4-17). In other words, it is determined whether the upper rank ID is set to the object information 350 for the object of the ID “0007”.

Since “0002” is set to the object information 350 as the upper rank ID for the object of the ID “0007”, it is determined that the upper rank object exists. The processor 22 evaluates the color of the cell of the upper rank object again (S4-18), and ends the procedure of FIG. 11B.

That is, the processor 22 determines the lower rank object of the group from which the upper rank object is chosen as the lower rank ID set as the object information 350 for the object of the ID “0002”, and the lower rank ID based on the group designation and the rating conditions which are stored according to the association.

In this example, the A group is chosen (the rating conditions A) and the IDs of the lower rank objects belonging to the A group are “0007” and “0005”. The processor 22 sets up the color of the cell of the object 201 of “solution means 1:0002” reflecting the lowest rating level among the rating levels of the lower rank objects of the selected group.

In this example, the rating level of the object of “0007” is “3” (no problem), the cell of the object 202 of “subject c:0007” is displayed in green. On the other hand, the rating level of the object of “0005” is “0” (no evaluation), the cell of the object 204 of “subject b:0005” is displayed in white.

For this reason, the processor 22 displays the cell of the object 201 of “solution means 1:0002” in white, which corresponds to “0” (no evaluation) which is the lowest rating level among the rating levels of the lower rank objects of the selected A group.

Next, the user chooses the object 204 of “subject b:0005”. The processor 22 performs the same processing as in the case where the object 202 of “subject c:0007” is chosen.

The user inputs “1” (significant problem) in the evaluating point input box 62. The processor 22 receives this (S4-14) and stores the evaluating point in the object storage portion 35 (S4-15). That is, “1” (significant problem) is set up as the rating level of the object information 350 for the object of the ID “0005.”

The processor 22 performs the color classification according to the rating level with respect to the cell of the object in the tree-structured diagram 200 (S4-16). Hence, the cell of the object 204 of “subject b:0005” to which the rating level “1” (significant problem) is set is displayed in purple.

Since the upper rank ID “0002” is set to the object information 350 for the object of the ID “0005”, the processor 22 evaluates the color of the cell of the upper rank object again (S4-18).

The ID of the lower rank object to which the A group is chosen belongs to the A group with respect to the object of “0002” in this example is “0007” and “0005.” The rating level of the object of the ID “0007” is “3” (no problem), and the cell of the object 202 of “subject c:0007” is displayed in green. On the other hand, the rating level of the object of the ID “0005” is “1” (significant problem), and the cell of the object 202 of “subject b:0005” is displayed in purple.

For this reason, the processor 22 displays the cell of the object 201 of “solution means 1:0002” in purple, corresponding to “1” (significant problem) which is the lowest rating level among the rating levels of the lower rank objects of the selected A group.

In the processing at the time of choosing the object 201 of “solution means 1:0002”, when the group selection radio button 74 is not selected, the rating conditions are not set to the rating condition input box 64.

As mentioned above, when the rating conditions are not set up, the evaluating point can be manually inputted to the evaluating point input box 62, and the user inputs the evaluating point manually.

In this case, the processor 22 determines whether the rating level is manually inputted in the evaluating point input box 62 (S4-12). Since the rating level is manually inputted to the evaluating point input box 62, the processor 22 receives the input rating level (S4-14), and stores the received rating level in the object storage portion 35 (S4-15).

The processor 22 performs the color classification according to the rating level with respect to the cell of the object on the tree-structured diagram 200 (S4-16), and processes as mentioned above according to the steps S4-17 and S4-18.

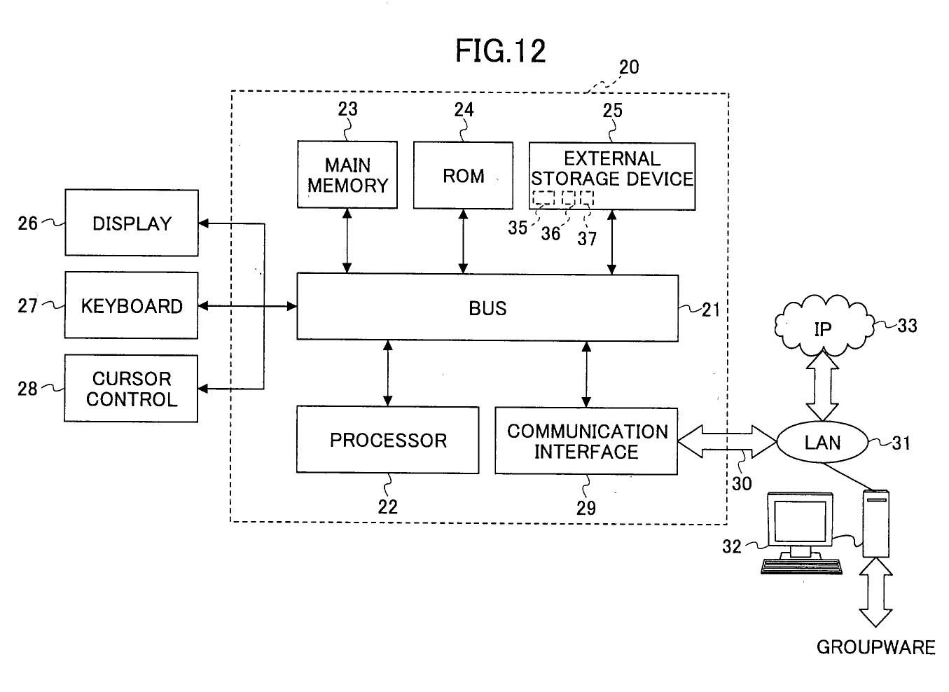

Next, a description will be given of a third preferred embodiment of the tree-structured diagram output method of the invention with reference to FIG. 12 through FIG. 18.

FIG. 12 shows a computer system which is embodied according to the present invention. In FIG. 12, the elements that are essentially the same as corresponding elements in FIG. 1 are designated by the same reference numerals, and a description thereof will be omitted.

Apart from the previous embodiment of FIG. 1, in the computer system of the present embodiment, the external storage device 25 includes an external information storage portion 37, in addition to the object storage portion 35 and the used-ID storage portion 36.

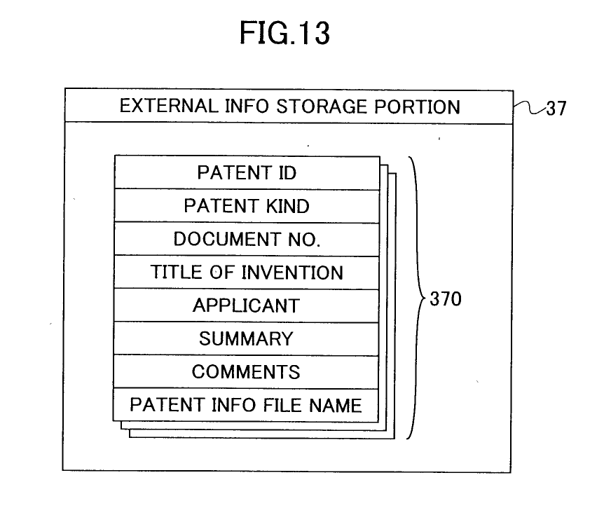

FIG. 13 shows the data stored in the external information storage portion 37 of the external storage device 25 in the computer system of FIG. 12. As shown in FIG. 13, the external information storage portion 37 is provided to store external information 370 on the basis of patent ID. The external information 370 includes the patent ID, the patent kind, the document number, the title of invention, the applicant, the summary, the comments, and the filename of a patent information file. The patent ID is provided as an identifier of external information stored in the external information storage portion 37. The patent kind is provided as an rating level of the patent information concerned, and the rating level is classified into four different ranks, including rank 0 (the patent is owned by the self-company), the rank A (the patent is owned by another company and the degree of significance is high), the rank B (the patent is owned by another company and the degree of significance is low), and the rank C (the evaluation is not yet made). The document number, the title of invention and the applicant are external information that is received from a database of an external patent information retrieval system. The summary and the comments are input information that is given by the user using an input operation. The patent information file is a file containing patent information corresponding to the document number that is received from the database of the external patent information retrieval system.

In the present embodiment, the external information storage portion 37 which stores the document number, the title of invention and the applicant constitutes an external information storing unit storing external information received from an external database. Moreover, the external information storage portion 37 which stores the patent kind constitutes the rating level storing unit to which the rating level received from the external information storing unit according to an input operation is stored.

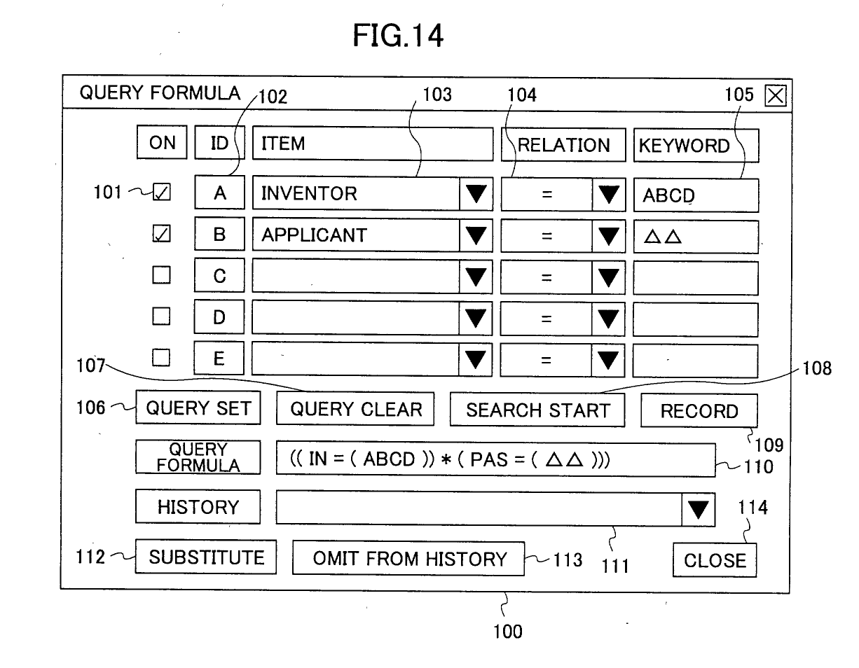

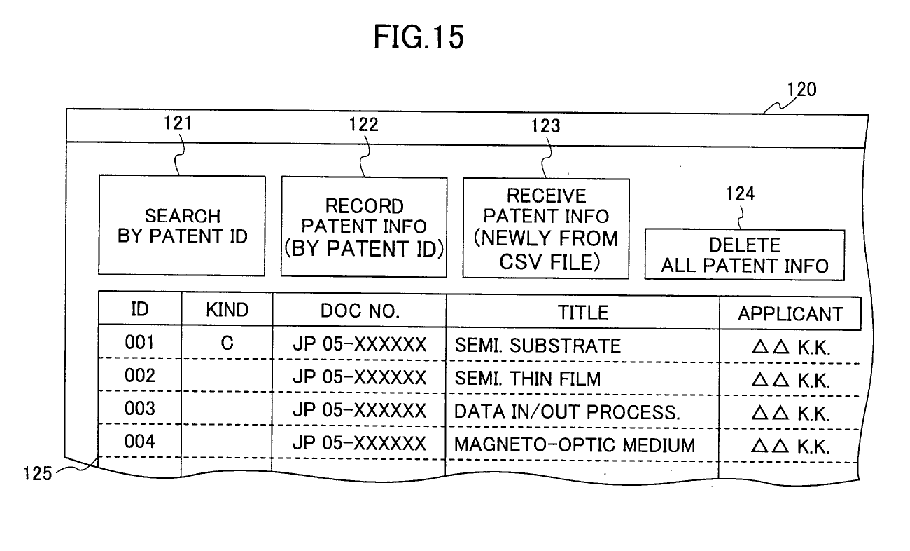

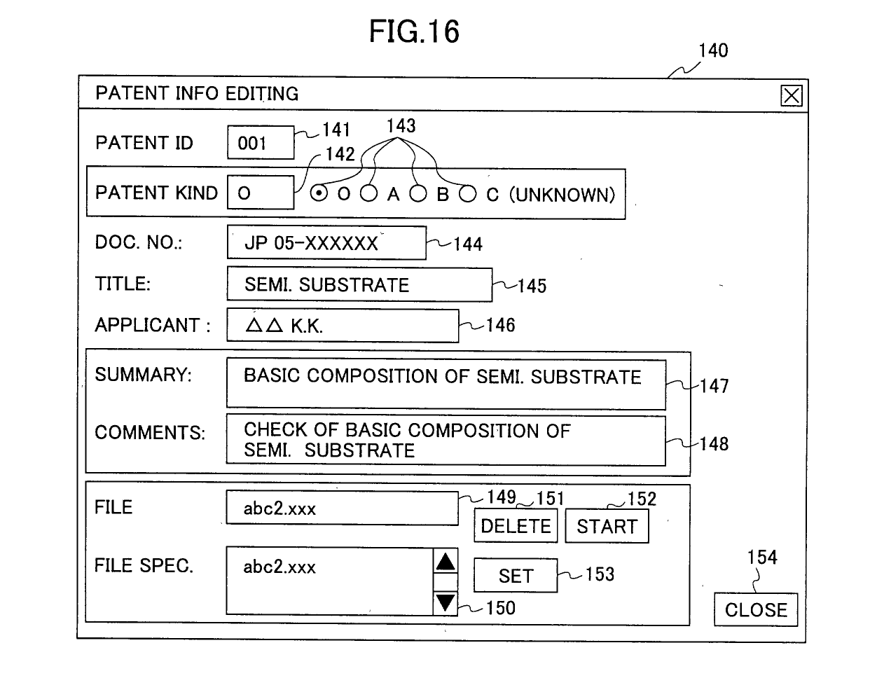

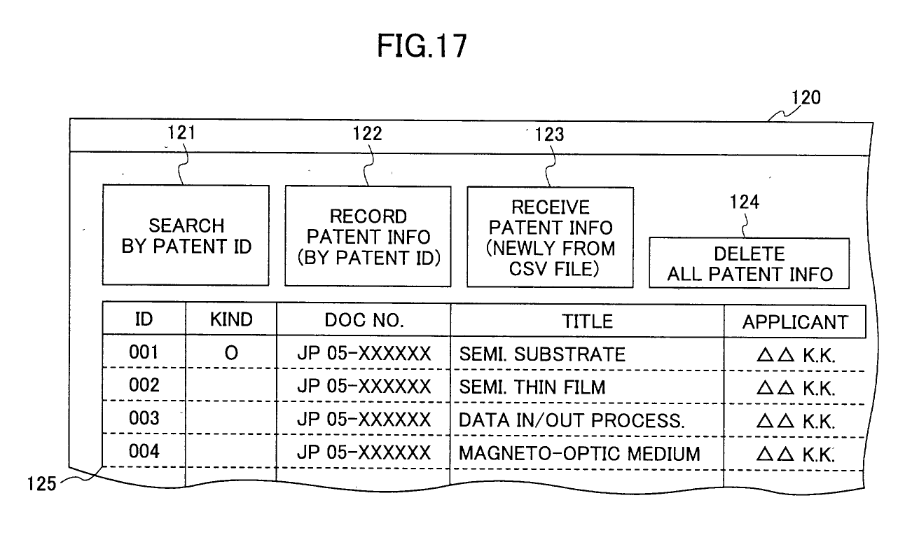

FIG. 14 shows a query input screen 100 in which a query formula is input in order to retrieve patent information. FIG. 15 shows a search result screen 120 in which a search result related to the input query is displayed. FIG. 16 shows a patent information editing screen 140 in which patent information is edited and an evaluation result is input. FIG. 17 shows a search result screen 120 after the evaluation result is input.

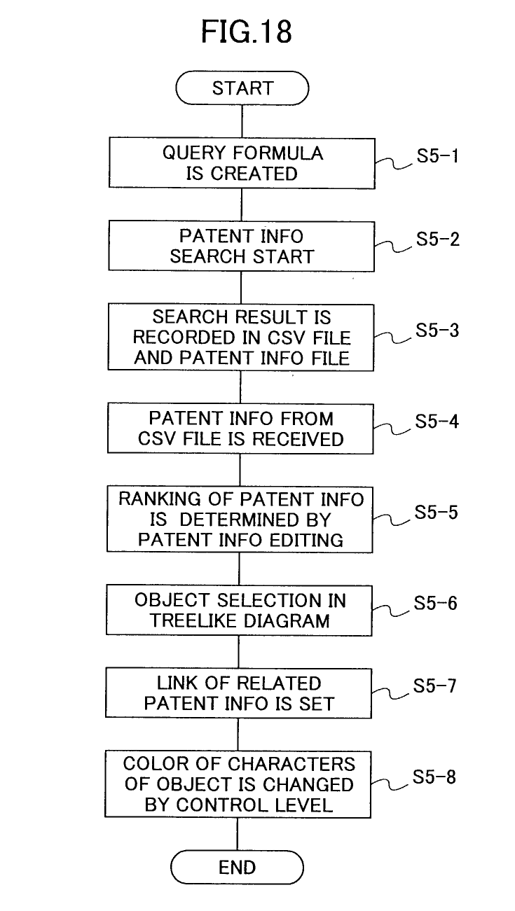

FIG. 18 shows a patent information procedure according to the third preferred embodiment of the tree-structured diagram output method of the invention.

As shown in FIG. 18, at a start of the patent information procedure, the processor 22 creates the query formula for searching the patent information first (S5-1). The user inputs the display command of the query formula input screen 100 shown in FIG. 14 using the cursor control 28, and the processor 22 receives the command and displays the query formula input screen 100 on the display device 26.

If the user performs the input to create the query formula in the query formula input screen 100, the processor 22 generates the query formula in accordance with the user input.

As shown in FIG. 14, two or more sets of the retrieval condition selection box 101, the retrieval ID display 102, the item setting box 103, the relation setting box 104, and the keyword input box 105 are established in the query formula input screen 100.

When it is used in order that these may set up the retrieval conditions, the query formula is created on the AND conditions.

Moreover, the formula creation button 106, the formula clear button 107, the start button 108, the history registration button 109, the formula display box 110, the history selection box 111, the formula substitution button 112, the history deletion button 113, and the close button 114 are further provided in the query formula input screen 100.

The retrieval condition selection box 101 is chosen when setting up the retrieval conditions with the same item setting box 103 of the line, the relation setting box 104, and the keyword input box 105. The retrieval ID display 102 is displayed like A, B, and C for each of the retrieval conditions. The item setting box 103 is used in order to choose the retrieval item.

With the item setting box 103, the user may select any of the inventor or the designer, the applicant or the patent owner (the patentee or the utility model owner), the official report number, the invention name, etc.

The relation setting box 104 is used in order to choose the relation with the keyword inputted with the item and the keyword input box 105 which are set up with the item setting box 103. In the relation setting box 104, the user may choose any of the symbols “=”, “<”, etc. The keyword input box 105 is used in order to input the keyword. The formula creation button 106 is clicked when creating the query formula based on the set-up retrieval conditions. The created retrieval formula is displayed in the formula display box 110.

The formula clear button 107 is clicked when clearing the created retrieval formula. The clicking of the clear button 107 clears the query formula currently displayed on the formula display box 110.

The search start button 108 is clicked when starting the patent information retrieval system. If the search start button 108 is clicked, the patent information retrieval system will be started, the created retrieval formula is stored in the query formula history storage portion (not shown) of the external storage 25.

The history registration button 109 is clicked when storing the query formula in the query formula history storage portion. The retrieval formula registered in the retrieval formula history storage portion is displayed in the history selection box 111, and the query formula can be chosen from the displayed formula.

The formula substitution button 112 is clicked when substituting for the formula display box 110 the query formula chosen with the history selection box 111.

The history deletion button 113 is clicked when choosing the query formula with the history selection box 111 and deleting the case index from the query formula history storage portion.

The close button 114 is used when closing the query formula input screen 100. When searching the patent information in which the applicant or the patent owner (the patentee or the utility model owner) is “ΔΔ” and the inventor or the designer is “ABCD”, the user sets up the retrieval conditions as shown in FIG. 14.

The user chooses the retrieval condition selection box 101 with respect to the retrieval ID “A”, and sets up the retrieval conditions that the inventor or the designer is “ABCD”. The user sets respectively “the inventor or the designer (IN)”, “=”, and “ABCD” in the item setting box 103, the relation setting box 104, and the keyword input box 105 with respect to the retrieval ID “A”.

Furthermore, the user chooses the retrieval condition selection box 101 with respect to the retrieval ID “B”, and sets up the retrieval conditions that the applicant or the patent owner (the patentee or the utility model owner is “ΔΔ” K.K. The user sets the respective items to “the applicant or the patent owner (PAS)”, “=”, and “ΔΔ” KK regarding the retrieval ID “B”.

When the user clicks the formula creation button 106, the processor 22 creates the retrieval formula “(IN=(ABCD))*(PAS=(ΔΔKK))” based on the set-up contents and it is displayed in the formula display box 110.

Hence, the processor 22 generates the query formula for searching the patent information in which the applicant or the patent owner (the patentee or the utility model owner) is “ΔΔ” and the inventor or the designer is “ABCD”. If the user clicks the start button 108, the processor 22 outputs the activate request to the patent information retrieval system, and the activation of the patent information retrieval system will be started.

The patent information retrieval system displays the retrieval screen (not shown) on the display device 26. The patent information retrieval system displays the retrieval formula “(IN=(ABCD))*(PAS=(ΔΔKK))” in the formula display box 110 of the retrieval formula input screen 100 on this retrieval screen as a retrieval formula.

When the user clicks the retrieval button (not shown) in the retrieval screen, the patent information retrieval system starts performing the retrieval of the patent information in accordance with the above-mentioned retrieval formula (S5-2).

The patent information retrieval system transmits the retrieval result to the computer system 20 through the LAN 31.

Based on the retrieval result sent by the patent information retrieval system, the user creates the list file of the CSV (comma separated value) format and the patent information file, and stores them into the external storage device 25 (S5-3).

The start button 121, the patent information registration button 122, the patent information taking-in button 123, the all patent information deletion button 124, and the searched list display button 125 are provided in the retrieval result display screen 120. In the present example, the four patent information items are searched in accordance with the above-mentioned retrieval formula. The patent ID, the patent classification, the official report number, the invention name, the applicant, etc. are displayed in the list display 125. The patent ID is provided for identification of the searched patent information. The patent classification is provided for indicating the significance of the patent information of the self-company and the other company.

As for the patent classification inputted by the user, “O” is set up when the patent is owned by the self-company, “A” is set up when the patent is owned by the other company and the significance is high, “B” is set up when the patent is owned by the other company and the significance is low, and “C” is set up when the ownership and the significance of the patent are undecided.

About the patent information of the 1st item displayed in the list display 125, “C” is set up as the patent classification.

The start button 121 is clicked when displaying the patent information which is specified by the patent ID in the list display 125 with the cursor control 28, and related with the patent ID.

The patent information registration button 122 is clicked when editing the patent information specified by the patent ID similarly and related with the patent ID, and storing it as a patent information file in the main memory 23.

The above-mentioned file of the CSV format is stored in order to retain the information with respect to the patent ID, the official report number, the invention name, and the applicant.

On the other hand, the patent information file is stored to retain the information indicated by the official report corresponding to the official report number stored in the file of the CSV format.

The patent information taking-in button 123 is clicked when taking in the information with respect to the official report number, the invention name, and the applicant newly from the file of the CSV format.

The all patent information deletion button 124 is clicked when deleting all the patent information items displayed in the list display 125.

When the user clicks the patent information taking-in button 123, the processor 22 takes in the information from the stored file of the CSV format, and displays it in the list display 125 as shown in FIG. 15 (S5-4).

If the user specifies the patent ID “001” and clicks the patent information registration button 122, the processor 22 displays the patent information of the patent ID “001” in the patent information edit display 140.

In the patent information edit display 140, the patent information can be edited (S5-5).

As shown in FIG. 16, the patent ID display 141, the patent kind input box 142, the patent classification selection radio button 143, the document number display 144, the invention title display 145, the applicant name display 146, the summary input box 147, the comment input box 148, the file designation box 149, the available file selection box 150, the delete button 151, the start button 152, the setup key 153, and the close button 154 are provided in the patent information edit display 140.

The patent ID which is selected as mentioned above is displayed in the patent ID display 141. The patent classification chosen by the patent classification selection radio button 143 is displayed in the patent kind input box 142.

The patent classification selection radio button 143 is provided with respect to each of the patent classification including the above-mentioned “O”, “A”, “B” and “C.”

The laid-open patent application number or the patent number is displayed in the document number display 144. The title of the invention is displayed on the invention title display 145. The applicant's name is displayed on the applicant name display 146. The official report number, the title of the invention, and the applicant name for the patent ID “001” are displayed in the document number display 144, the invention title display 145 and the applicant name display 146 of the display screen 120.

The summary of the patent information is inputted into the summary input box 147. The comment of the patent information is inputted into the comment input box 148. The contents (the summary and comment) inputted in the summary input box 147 and the comment input box 148 are stored in the external information storage portion 37.

The file name of the patent information file which is stored as mentioned above is displayed in the file designation box 149. In the file designation box 149, the input of the file name of another file is possible. The file name of the file inputted with the patent information file and the file designation box 149 is displayed in the available file selection box 150.

The delete button 151 is clicked when eliminating the display of the file name of the patent information file chosen with the available file selection box 150. The retrieval start button 152 is clicked when starting the retrieval of the patent information file chosen by the available file selection box 150. The setup key 153 is clicked when setting the patent information file inputted into the file designation box 149 as the available file selection box 150.

The file name set as the available file selection box 150 is stored in the external information storage portion 37 as a file name of the related patent information file. The close button 154 is clicked when closing the patent information edit display 140.

When the user chooses any of the patent classification selection radio buttons 143 in the patent information edit display 140, the processor 22 stores the selected patent classification into the external information storage portion 37, and gives the ranking of the significance of the patent owned by the self-company or the other company (S5-5).

The patent information for the patent ID “001” before the setting of the patent information edit display 140 is performed is set to the patent classification “C” (the judgment of the ownership and significance of the patent is undecided) as mentioned above (FIG. 15).

When the user chooses the patent classification selection radio button 143 corresponding to the “O”, the processor 22 stores the “O” into the external information storage portion 37 as the patent classification of the patent ID “001”. Thereby, the ranking of the significance of the patent is reflected in the external information storage portion 37.

In addition, the processor 22 switches and displays the patent classification “O” with respect to the patent information for the ID “001” in the list display 125, as shown in FIG. 12.

The user chooses the object in the worksheet of the tree-structured diagram 40 of FIG. 5 with the cursor control 28, and inputs the display command of the property setting screen 50 by using the control panel.

In the present embodiment, the user chooses as the individual technical subject 43 “the subject B:0004”, for example.

The processor 22 receives the selection of the above-mentioned object and the display command of the property setting screen 50, and displays the property setting screen 50 with respect to the selected object on the display device 26 (S5-6).

In the property setting screen 50, the candidate list selection section 89 is indicated as the patent information edited by the patent information edit display 140, and the patent information list stored in the external information storage portion 37 is displayed.

The candidate list selection section 89 is displayed including the patent ID, the patent classification, the document number, the invention title, and “001, [O], JP05-______ and the semiconductor substrate” are displayed for the patent information which is edited as mentioned above.

When two or more patent information items are stored in the external information storage portion 37, the list of the patent information items is displayed by the pull-down operation in the candidate list selection section 89.

When the user chooses the patent information from the list, the selected patent information item is displayed in the candidate list selection section 89.

When the selected patent information item is displayed in the candidate list selection section 89 and the link setup key 90 is clicked, the processor 22 stores the patent ID of the related patent information into the object storage portion 35.

In the present embodiment, the patent ID “001” is stored into the object storage portion 35 as the related patent information for the object information 350 of the ID “0004”. Thereby, the link setup of the patent information on the patent ID “001” is carried out with the selected object (S5-7).

When the patent information for the patent ID “001” in which the user did [above-mentioned] the link setup in the patent ID selection section 83 is chosen, the processor 22 displays the patent information items for the patent ID “001” in the document number display 81, the applicant name display 82, the invention title display 84, the patent classification display 85 and the summary display 86, respectively.

Furthermore, the processor 22 displays the patent classification in the management level display 80 reflecting the contents of the setting of the patent classification display 85.

When two or more patent information items exist as the related patent information, the processor 22 displays the upper rank patent classification of the rating level on the management level display 80 as the patent classification of those patent information items.

The rating level of the patent classification is determined such that the rating level “O” is the highest, and it is in the order of the rating level “A”, “B” and “C”. For example, when the patent information with the rating level “B” and the patent information with the rating level “O” coexist, “O” is displayed on the management level display 80.

In the present embodiment, since the patent classification “O” is set up for the patent ID “001”, the management level display 80 is displayed as the “O.”

The processor 22 changes the color of the characters of the object in the tree-structured diagram 40 according to the management level displayed by the management level display 80 of the related patent information (S5-8).

The above-mentioned management level corresponds to the patent classification of the highest rating level among the patent classifications of the external information 370 related with each object as mentioned above. That is, the processor 22 switches the color of the characters of each object so that the patent classification of the highest rating level may be reflected among the patent classifications of the external information 370 related with each object.

In the present embodiment, the color of the characters of each object is changed to any of red, purple, blue and black in accordance with the management level “O”, “A”, “B”, and “C”, respectively. Specifically, the processor 22 changes the color of the characters of the individual technical subject 43 of the “subject B:0004” to red, which corresponds to the management level “O” displayed on the management level display 80.

When neither the case where the object is not related with patent information, nor the patent classification is set up, the color of the characters of the object is changed to black which corresponds to the management level “C”, and it is displayed.

Thus, the patent classification of the external information storage portion 37 is used in order to distinguish the color of the character of the object of the tree-structured diagram.

As described in the foregoing, in the above-mentioned embodiments, the following effects can be acquired.

In the above-mentioned embodiments, the tree-structured diagram is outputted based on the upper rank ID set up as the ID and the property of the specified object, and the lower rank ID. For this reason, the tree-structured diagram can be outputted efficiently.

In the above-mentioned embodiments, the object is associated by assigning the ID specific to each object for every object, and associating the ID. Thereby, the associated objects can be specified by the ID.

In the above-mentioned embodiments, when assigning the ID and the non-used ID does not exist, the following value is assigned by consecutive numbers, and when non-used ID exists, the non-used ID is assigned. For this reason, the non-used ID can be used efficiently.

In the above-mentioned embodiments, when it is the same ID as that of the object with which the input upper rank ID or the lower rank ID is chosen, it considers as the error. Thereby, the setup operation related to the object with itself can be prevented.

In the above-mentioned embodiments, the upper rank ID of the selected object is made to be restricted to one. Thereby, the upper rank object to the lower rank object can be restricted to one, and can display association of the object intelligibly by the tree-structured diagram.

In the above-mentioned embodiments, the lower rank ID of the selected object makes the multi-statement possible. Thereby, two or more lower rank objects can be associated to the upper rank object. For this reason, two or more solution means can be set up to the one subject, and the multi-statement of the subject can be carried out to one solution means.

In the above-mentioned embodiments, the object can be inserted on the tree-structured diagram by adding the object and setting up the upper rank ID or the lower rank ID with respect to the object. The information for this outputting the tree-structured diagram outputted before is utilized, and the new tree-structured diagram can be outputted.

In the above-mentioned embodiments, the objects and the property information of the objects in the worksheet of the tree-structured diagram 40 are associated by the IDs. Even when the objects in the worksheet of the tree-structured diagram 40 are updated, the association of the objects and the property information is maintained. For this reason, even when the objects are updated, the association of the upper rank object and the lower rank object based on the upper rank ID and the lower rank ID in the property information is maintained.

In the above-mentioned embodiments, the upper rank ID and the lower rank ID are stored as the property of each object. It may replace with this, among these the upper rank ID may be stored as a property of each object. Moreover, it is possible to store the lower rank ID as a property of each object. The item stored as the property information can be reduced by doing in this way.

In the above-mentioned embodiments, the input of the object name is performed on the property setting screen 50, but it is possible to input the object name in the worksheet indicating the tree-structured diagram 40. In this case, only when the cell of the position which can input the object is chosen, it is good also as the setup of the object being possible. Moreover, when the object name is inputted in this case, it is possible to assign the ID.

In the above-mentioned embodiments, the objects are associated by inputting the lower rank ID manually in the property setting screen 50, but it is possible to associate the objects in the worksheet indicating the tree-structured diagram 40, so that the objects are associated by setting up the ruled line 45. In this case, only when the one hierarchy is different, it is good also as possible in the association.

In the above-mentioned embodiments, the tree-structured diagram 40 is displayed on the worksheet of the spreadsheet software. It may replace with this and the tree-structured diagram 40 may be displayed using another software which does not have the table arranged in rows and columns. In this case, it may replace with having specified the cell in the present embodiment, and having set up the property in the property setting screen 50, the position on which the object is displayed may be set up, and the property may be set up similarly. Moreover, based on the association of the objects according to the set-up upper rank ID and the lower rank ID, it is automatic and the arrangement position of the object in the tree-structured diagram may be set up.

In the above-mentioned embodiments, the tree-structured diagram representing the association of the subject and its solution means, and the relation of the objects expressed by the tree-structured diagram in the present invention is not restricted to these elements. As long as it is the relation of the object which can be expressed using the tree-structured diagram, no matter it may be what object, it is possible to output the tree-structured diagram by the present invention.

It is possible to apply the tree-structured diagram of the present invention to the functional composition, the mechanism composition, the program processing, the organization view, etc.

For example, when displaying the functional composition using the tree-structured diagram of the present invention, as shown in FIG. 10, it is possible to develop the functions, such as the 3rd level, the 2nd level, the 1st level, etc.

The present invention is not limited to the above-described embodiments, and variations and modifications may be made without departing from the scope of the present invention.

Further, the present invention is based on Japanese priority application No. 2001-251584, filed on Aug. 22, 2001, Japanese priority application No. 2001-282414, filed on Sep. 17, 2001, Japanese priority application No. 2001-282415, filed on Sep. 17, 2001, and Japanese priority application No. 2002-204207, filed on Jul. 12, 2002, the entire contents of which are hereby incorporated by reference.

What is claimed is:

1. A method of outputting a tree-structured diagram representing association of objects, comprising the steps of:
assigning an identifier, which is specific to each of the objects, to every object;
selecting a first object from among the objects;
storing an identifier of the selected first object into a first storage portion;
selecting a second object, different from the first object, from among the objects;
storing an identifier of the selected second object into a second storage portion;
associating the identifier of the first storage portion with the identifier of the second storage portion so that the association of the identifiers of the first and second objects is obtained; and
outputting a tree-structured diagram representing the association of the first and second objects, based on the association of the identifiers obtained in the associating step.

2. The method of claim 1 further comprising:
setting the first object as an upper rank object; and
setting the second object as a lower rank object.

3. The method of claim 2 wherein the step of selecting the first object is provided to select only one object from among the objects as the first object, and the step of selecting the second object is provided to select two or more objects from among the objects as the second object.

4. The method of claim 1 wherein the identifier assigning step comprises:
counting the number of the objects;
storing the identifiers, which are already assigned to the respective objects by the identifier setting step, into a third storage portion; and
determining whether the number of the objects obtained in the count step matches with the number of the already assigned identifiers.

5. A computer program embodied therein for performing a tree-structured diagram output procedure to output a tree-structured diagram representing association of objects, the computer program comprising:
identifier setting program code means for assigning an identifier, which is specific to each of the objects, to every object;
first selection program code means for selecting a first object from among the objects;
first storage program code means for storing an identifier of the selected first object into a first storage portion;
second selection program code means for selecting a second object, different from the first object, from among the objects;
second storage program code means for storing an identifier of the selected second object into a second storage portion;
association program code means for associating the identifier of the first storage portion with the identifier of the second storage portion so that association of the identifiers of the first and second objects is obtained; and
output program code means for outputting a tree-structured diagram representing the association of the objects, based on the association of the identifiers.

6. The computer program of claim 5 further comprising:
first assignment program code means for assigning the first object, selected by the first selection program code means, as an upper rank object; and
second assignment program code means for assigning the second object, selected by the second selection program code means, as a lower rank object.

7. The computer program of claim 6 wherein the first selection program code means is provided to select only one object from among the objects as the first object, and the second selection program code means is provided to select two or more objects from among the objects as the second object.

8. The computer program of claim 5 wherein the identifier setting program code means comprises:
count program code means for counting the number of the objects;
third storage program code means for storing the identifiers, which are already assigned to the respective objects by the identifier setting program code means, into a third storage portion; and
determination program code means for determining whether the number of the objects matches with the number of the already assigned identifiers.

9. A method of outputting a tree-structured diagram representing association of objects, comprising the steps of:
assigning an identifier, which is specific to each of the objects, to every object;
setting an identifier of an upper rank object among the objects as an upper rank identifier;
setting identifiers of lower rank objects among the objects as lower rank identifiers;
storing association of the upper rank identifier and the lower rank identifiers into a storage portion;
classifying the lower rank objects into a plurality of groups in accordance with input operations; and
outputting a tree-structured diagram representing the association of the objects, based on the association of the upper and lower rank identifiers stored in the storage portion, such that each of the plurality of groups with respect to the lower rank objects is recognizable.

10. The method of claim 9 further comprising the steps of:
storing an input rating level for each of the lower rank objects into a rating level storage portion;
selecting a group from among the plurality of groups;
activating the rating level stored in the rating level storage portion for one of the lower rank objects included in the selected group; and
displaying the activated rating level for the selected group.

11. The method of claim 10 wherein the displaying step is provided such that, when the selected group includes two or more lower rank objects, a lowest rating level among the rating levels of the lower rank objects is displayed for the selected group.

12. The method of claim 10 wherein the displaying step is provided such that, when the selected group includes two or more lower rank objects, a rating level that is the same as the rating level of one of the two or more lower rank objects is displayed for an upper rank object associated with the two or more lower rank objects.

13. A computer program embodied therein for performing a tree-structured diagram output procedure to output a tree-structured diagram representing association of objects, the computer program comprising:
identifier setting program code means for assigning an identifier, which is specific to each of the objects, to every object;
first setting program code means for setting an identifier of an upper rank object among the objects as an upper rank identifier;
second setting program code means for setting identifiers of lower rank objects among the objects as lower rank identifiers;
storage program code means for storing association of the upper rank identifier and the lower rank identifiers into a storage portion;
grouping program code means for classifying the lower rank objects into a plurality of groups in accordance with input operations; and
output program code means for outputting a tree-structured diagram representing the association of the objects, based on the association of the upper and lower rank identifiers stored in the storage portion, such that each of the plurality of groups with respect to the lower rank objects is recognizable.

14. The computer program of claim 13 further comprising:
first program code means for storing an input rating level for each of the lower rank objects into a rating level storage portion;
second program code means for selecting a group from among the plurality of groups;
third program code means for activating the rating level stored in the rating level storage portion for one of the lower rank objects included in the selected group; and
fourth program code means for displaying the activated rating level for the selected group.

15. The computer program of claim 14 wherein the fourth program code means is provided such that, when the selected group includes two or more lower rank objects, a lowest rating level among the rating levels of the lower rank objects is displayed for the selected group.

16. The computer program of claim 14 wherein the fourth program code means is provided such that, when the selected group includes two or more lower rank objects, a rating level that is the same as the rating level of one of the two or more lower rank objects is displayed for an upper rank object associated with the two or more lower rank objects.
